(19) United States
(12) Patent Application Publication
(10) Pub. No.: US 2017/0187648 A1
(43) Pub. Date: Jun. 29, 2017

(54) SIGNALLING FROM PORT CONNECTIONS TO SWITCHES

(71) Applicant: Hirschmann Automation and Control GmbH, Neckartenzlingen (DE)

(72) Inventors: Stephan KEHRER, Dusslingen (DE); Zbigniew PELZER, Neckartailfinger (DE)

(21) Appl. No.: 15/302,121

(22) PCT Filed: Apr. 9, 2015
(86) PCT No.: PCT/EP2015/057782

§ 371 Date: Oct. 5, 2016

(30) Foreign Application Priority Data
Apr. 9, 2014 (DE) 10 2014 206 871.1

(51) Int. Cl. H04L 12/947; H04L 12/24

(52) U.S. Cl. CPC H04L 49/25; H04L 41/12

(57) ABSTRACT

A method of operating a network that has network infrastructure devices (1, 2) that have multiple ports and that are connected or are connectable to each other for data transmission via respective cables inserted into the ports that each have a signaling means that can be switched between at least two signaling states, characterized in that a signaling means of a port of the one network infrastructure device (1) and a signaling means of a port of another network infrastructure device (2) are brought into a signaling state indicating that they belong together so that it is easy to determine that the ports belong together.

The invention relates to a method of operating a network having network infrastructure devices that have multiple ports and that are connected or are connectable to each other for data transmission via respective cables inserted into the ports that each have a signaling means that can be switched between at least two signaling states, according to the features of the preamble of claim 1.

The invention is based on the known topology of a network having network infrastructure devices having multiple ports (also referred to as an input), and where the network infrastructure devices are connected or are connectable to each other for data transmission via respective cables inserted into the ports that each have a signaling means that can be switched between at least two signaling states. The signaling means of the ports of the network infrastructure devices via which data are currently being transmitted, for example, flash during data transmission. If no data are being transmitted, the respective signaling means are switched off.

It is often difficult to inspect several switches and/or terminals in terms of the correctness of the physical layout and the individual port connections in a system (network having connected devices) having several cable connections, in particular Ethernet cable connections. Although the Industrial HiVision program from Hirschmann, with its topology-recognition functionality, provides excellent service in this case, this possibility is not always available.

Furthermore, HiDiscovery from Hirschmann makes it possible to assign the identified switch devices to the devices that are physically present in the network with the aid of the device signal function by inducing the sought device “to flash” (all port LEDs of the switch flash synchronously).

At the moment, however, it is not always easy to trace the ends of a single inserted cable (and, therefore a port) to its other end (i.e. to the adjacent port). For this purpose, one must usually “travel,” using the hand along the cable from one end to the other end of the cable.

This can be cumbersome, however, particularly in the case of long cables and in the case of cables that are tangled with other cables, requires a great deal of concentration, and can be nearly impossible in the case of a closed cable harness.

The problem addressed by the invention is therefore that of improving a method of operating a network in terms of the cabling of network infrastructure devices to each other.

This problem is solved by the features of claim 1.

According to the invention, a signaling means of a port of the one network infrastructure device and a signaling means of a port of another network infrastructure device are brought into a signaling state indicating that they belong together. The solution is based on the idea that a port of a network infrastructure device is connected via a cable to a port of another network infrastructure device. If a check is supposed to be carried out to determine whether it is desirable that precisely these two ports of the two network infrastructure devices are correctly connected to each other via the cable, these two ports are accessed using an appropriate command, for example, from a network administrator, and the signaling means of these ports, for example, light-emitting diodes, are brought into a signaling state from which it can be deduced that these two ports are correctly connected to each other via the cable. One example to be mentioned here is that the signaling state is a permanent illumination of the light-emitting diodes or a flashing with a certain frequency. A further method of determining that the ports belong together is also that these two ports are accessed by a suitable link discovery protocol, such as, for example, LLDP (or any other type of suitable protocol) and their signaling means, for example, light-emitting diodes again, are brought into a signaling state from which it can be deduced that these two ports are correctly connected to each other via the cable. Advantageously, it can therefore be easily determined, according to the invention, that the ports belong together.

Alternatively, or additionally, the idea is considered to be that the network infrastructure devices are not cabled to each other yet or are not all interconnected, and a port of the one network infrastructure device and a port of another network infrastructure device should be connected to each other via the cable. In this case as well, the signaling means of the two ports of the two network infrastructure devices that are supposed to be connected to each other are brought into a signaling state indicating that they belong together by a suitable command from the outside. In this case as well, it is conceivable that the signaling means, such as the light-emitting diodes, for example, of the two ports are permanently switched on for a certain time in order to signal that the two ports whose light-emitting diodes are permanently illuminated should be connected to each other via the cable. In this way, the installer of a network can determine, quickly and at a glance, which ports of the network infrastructure devices should be connected to each other and can plug the cable into the appropriate ports. Furthermore, it is also conceivable that a combination of this function and the link-blink function is implemented. This could be implemented, for example such that the two ports to be connected (but that have not yet been plugged into) are signaled in a certain scheme in order to identify them. If the connection is then established, the link-blink method is switched on and, an apparently different signaling shows that the two ports have actually been correctly connected to each other as desired.

In this case, it is important and advantageous that the signaling means of the particular port of the two network infrastructure devices are not only brought into a signaling state indicating that they belong together, but also that a difference from the signaling state of the other signaling means of the ports of the particular respective network infrastructure device or all other network infrastructure devices (for example in the case in which multiple network infrastructure devices are combined in a patch panel) is recognizable. For example, multiple network infrastructure devices, such as switches, are combined one above the other and next to each other in a typical way in a rack or a patch panel. These individual switches have a series of ports (for example next to each other, or one above the other), and a respective signaling means, for example, a light-emitting diode, is generally provided adjacent each port. In the normal operating case, when such a patch panel has been cabled and started up, a plurality of light-emitting diodes flashes simultaneously. In this case, it is important that the ports to be signaled that are supposed to be connected to each other via a cable or that should be checked to determine whether these two ports have been correctly connected to each other via a cable, have their two signaling means brought into a signaling state that not only makes it possible to recognize that these two ports belong together, but also differs considerably from the signaling states of the other ports of the other network infrastructure devices. At this point, it is conceivable that, for the normal operating case, the signaling means of the ports of the network infrastructure devices flash during data transmission as usual depending on data transmission, and the two ports to be made recognizable are made detectable by their signaling means, for example, being permanently illuminated, flashing with a different frequency, or switching to a different color. In this regard, in one refinement of the invention the signaling means of the two respective ports are simultaneously permanently illuminated, have the same color, or flash synchronously with each other, while the other ports of the network infrastructure devices flash, have a different color, or flash with a different frequency.

In one refinement of the invention, in order to differentiate the ports, the signaling means of the two respective ports are simultaneously permanently illuminated and the other signaling means of the ports at least of these two network infrastructure devices, in particular of all network infrastructure devices of the network, are switched off or have a different brightness than that of the illuminated ports. As a result, the two ports to be recognized are clearly identified as belonging together in that they differ considerably from the ports at least of the two network infrastructure devices, preferably from all network infrastructure devices of the network or the patch panel.

In addition, the following possibility also exists, namely that the respective signaling means (for example, the port LEDs) flash in an identical, dynamic flashing sequence, for example the flashing sequence increases from slow to fast within a certain time and then decreases again (or vice versa), or said signaling means flashes in a certain Morse code or the like.

Alternatively, or additionally, in one refinement of the invention the signaling means of the two respective ports flash synchronously with each other and the other signaling means of the ports at least of these two network infrastructure, in particular of all network infrastructure devices of the network, flash in a phase-shifted manner, are switched off, or have a different brightness than that of the illuminated ports. An unambiguous differentiation between the signaling means of the ports that signal the normal data transmission, and of the two ports that are supposed to be connected to each other or that are connected to each other, is therefore also possible.

In one refinement of the invention, it is particularly advantageous when the signaling means of the two respective ports are activated in the same color, while the other ports have a different color. This can be achieved particularly easily by using two-color signaling means, such as, for example, two-color light-emitting diodes. In this way, it is feasible that all signaling means of the ports of the network infrastructure devices are illuminated, for example, flash depending on the transmitted data, during normal operation of the data transmission, but the two ports that are connected to each other or that are supposed to be connected to each other flash with the same regular or irregular frequency, although in a different color. Due to the color difference, it is possible to very quickly determined which two ports belong together.

The start command to switch the signaling means of the two respective ports into a state indicating they belong together can be triggered by an operator, for example, the network administrator, from a stationary or a mobile external device, and it is also conceivable to initiate this triggering via a network infrastructure device itself, in particular in software installed therein. While it is possible, on the one hand, that the two network infrastructure devices whose ports are supposed to be made recognizable as belonging together are within the same field of view, the recognizability can also be triggered via the external stationary or mobile device, such as, for example, a network management station, if the two network infrastructure devices are located at a distance from each other such that the two ports that have been made visible are no longer detectable.

This applies, in particular, when the two network infrastructure devices are located at a great distance from each other or in different rooms. For example, an operator at one network infrastructure device can be provided with the information that the plug of the cable should be plugged into the port in which the signaling means is illuminated in blue, whereas the other signaling means are yellow. If the two network infrastructure devices are located in different rooms, the second operator can also be notified that the other plug of the cable should also be plugged into the port of the second network infrastructure device whose signaling means are illuminated in blue, and the other signaling means of the ports flash yellow in this case as well.

In one refinement of the invention, the signaling means of the one network infrastructure device and the signaling means of another network infrastructure device are initially identified and then a signaling means of a port of this one network infrastructure device and a signaling means of a port of this other network infrastructure device are brought into a signaling state indicating that they belong together. As a result, the effectiveness of the method is further increased, since an operator or installer of a network is signaled, via the signaling means of the one network infrastructure device, that this network infrastructure device should be inspected or recabled. The same also applies for the second network infrastructure device. Therefore, after the two network infrastructure devices per se have been identified, the above-described method can then be carried out in order to identify the particular port that is supposed to be inspected or cabled, at the two network infrastructure devices that have been initially identified per se.

In other words, it is therefore proposed to provide a “link-blink” (link signal) function, in particular to provide this in operating programs and devices, in particular switches, that, when started up, cause the link LEDs on both sides of a given connection to flash in a clearly recognizable manner (preferably synchronously) and to therefore unambiguously mark the two ends of the cable.

The port LEDs of the two devices in which the link signal function was started and that belong to the same link could flash in the same rhythm, for example.

In order to simplify the identification of the devices that are physically connected via the link in a larger system, a coupling of the device signal function to the link signal function (“link-blink”) is conceivable in addition to the simple link signal function. This coupling could be carried out in one of the two ways mentioned in the following:

1. When a port is selected whose link partner is being sought, first the device signal function of the two devices physically connected via the link is started and then, after a certain amount of time (or after acknowledgment by the user), the device signal function is switched to the link signal function at the connected ports, at both of these two devices.

2. When a port is selected whose link partner is being sought, the device signal function of the two devices physically connected via the link is started. All the port LEDs of the two devices then flash synchronously. The identification of the specific connected ports via the link signal function is achieved by the port LEDs of the two physically connected ports that are supposed to be identified flashing in a phase opposite that of the other port LEDs of the two devices.

In this way, it is possible to very quickly and easily identify the correct devices and the specifically affected ports.

It would be conceivable to start this link identification function (link signal function) from the HiDiscovery program or via the WebInterface or from Industrial HiVision by clicking the relevant port (that belongs to the link) and selecting the flash function from a context menu.

Since it is not always practical to bring a laptop along, it would be possible to provide an app for mobile devices, as an alternative. In this case, when the user with the mobile device is in the same network as the switch on which he would like to carry out the link signal function, this user could access the desired switch either directly via the IP address or identify the desired switch via alternative possibilities (for example “simultaneously flashing” all the network infrastructure devices such as, for example switches or routers, with the device signal function and confirm via the app as soon as the desired device flashes). Next, the device could be graphically represented and the user could select the network port whose link partner he would like to identify.

The flashing itself could be implemented via multiple possibilities. It would be conceivable, for example to cyclically switch one of the two ports off and on (forced link-down/link-up actions), or the flashing of two adjacent ports could be started, for example via a MIB parameter. In any case, a possibility should be selected that does not adversely affect the connection between the two devices during implementation of the link signal function.

It is also conceivable to activate the “link-blink” function via a control unit of the network infrastructure device, in particular, of the switch or the router. This control unit can be present as an alternative or in addition to mobile devices such as notebooks, smart phones, or the like.

It is also conceivable that the function according to the invention is not triggered directly in the area in which the at least one network infrastructure device is located; the two devices that are connected to each other via the cable are generally spatially close to each other, and so both devices are within the range of view of an operator who can determine that the function according to the invention was activated. Moreover, it is also possible to determine which cable is connected via both of its ends to the particular network infrastructure device. It is also possible that the two devices that are connected to each other via the cable are not located spatially close to each other. It is also possible that the function according to the invention is not triggered in location near a device or both devices; in such a case, it is conceivable that the function according to the invention is triggered by a highly remote network management station that is connected to the network infrastructure devices via a suitable network and connections (wireless or wired). In cases in which the function is not triggered directly at the at least one network infrastructure device, it is also conceivable to utilize the function according to the invention in such a way that two or more than two persons are connected to each other via suitable communication means, for example a telephone, and, after the “link-blink” function is triggered, these persons identify the cable that is plugged via its particular end into the right port of a particular network infrastructure device.

Alternatively, thereto, it is also conceivable to unplug the cable, via its plug, from a device and connect another suitably designed device therebetween, which then triggers the function according to the invention at the two network infrastructure devices. Depending on the transmission protocol, this intermediate connection of a suitably designed device results in an interruption or in no interruption of the data transmission of the cable whose plug has been unplugged from the network infrastructure device.

Advantages of this idea:

This link signal function (“link-blink”) makes it possible to better understand and monitor the physical layout of a complicated communication system, since the two ends of a cable, in particular an Ethernet cable, and, therefore, the two (or more) ports that belong together are easier to find.

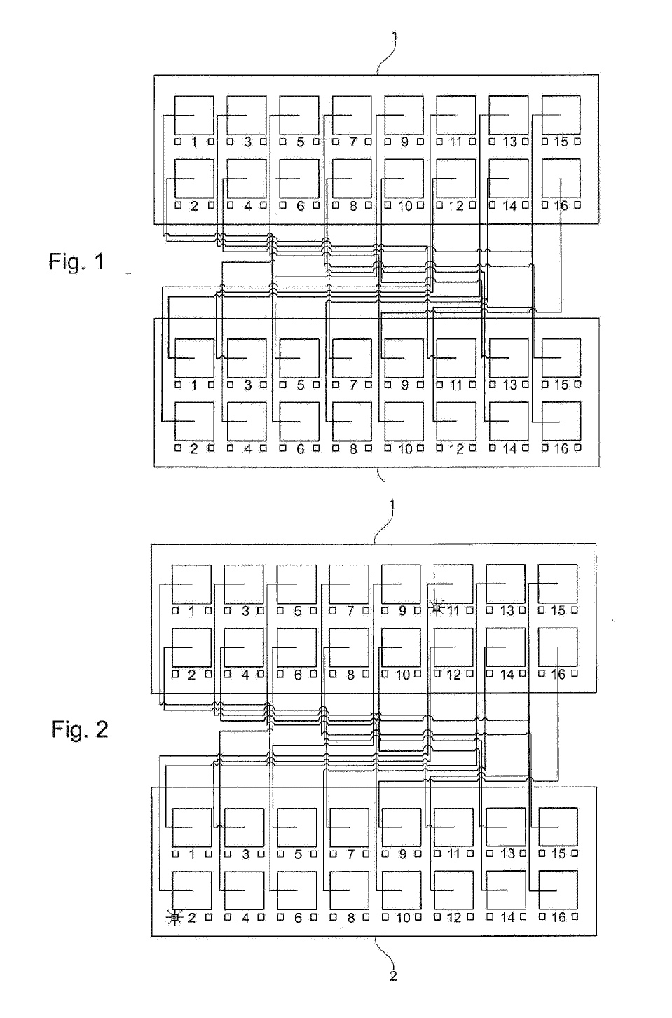

The invention is illustrated for example with reference to two network infrastructure devices in FIGS. 1 and 2.

FIG. 1 shows a network infrastructure device 1 and another network infrastructure device 2 of a network, although more than two network infrastructure devices are generally present within the network. These are generally also not located adjacent each other, as represented in FIG. 1, but rather, for example are installed in different rooms, in relatively large racks, or even far from each other at different locations.

Both network infrastructure devices have ports 1-16 that, in this embodiment, are already connected to each other via network cables, as shown. Due to the confusing cabling, as is apparent in FIG. 1 between the two network infrastructure devices 1 and 2, it cannot be readily determined, for example that the ports 2 and 11 are connected to each other via a network cable. In order to check whether these two ports are correctly connected to each other or, if cabling has not yet been carried out and the port 11 of the network infrastructure device 1 and the port 2 of the network infrastructure device 2 are supposed to be connected to each other, the above-described invention is utilized, by the signaling means of these two ports being activated. This is apparent in FIG. 2 that shows that the signaling means of the port 11 of the network infrastructure device 1 is activated, just as the signaling means of the port 2 of the network infrastructure device 1 is also activated. In this case, if the cabling has already been carried out, it can be verified that these two ports have been correctly connected to each other via the respective network cable.

If the ports have not yet been connected by network cables, the activation (for example flashing) of the signaling means of the port 11 of the network infrastructure device 1 and of the port 2 of the network infrastructure device 2 simplifies the correct insertion of the network cable for the start-up at least of these two network infrastructure devices 1, 2. For the sake of completeness, it is mentioned that, in these two embodiments shown in FIGS. 1 and 2, a signaling means is assigned to each port, by means of which the “link-blink function” can be carried out, and additionally another signaling means is present that is activated via its ports depending on the data exchange between the network infrastructure devices.

It is also possible, of course, to utilize only one signaling means per port that is activated when the “link-blink function” is carried out and otherwise signals the normal network traffic by irregular illumination, as a rule.

1. A method of operating a network having network infrastructure devices that have multiple ports and that are connected or are connectable to each other for data transmission via respective cables inserted into the ports that each have a respective signaling means that can be switched between at least two signaling states, the method comprising the step of:
bringing a signaling means of a selected port of the one network infrastructure device and a signaling means of a selected port of another network infrastructure device are brought into a signaling state indicating that they belong together.

2. The method as recited in claim 1, wherein the signaling means of the two selected ports are simultaneously permanently illuminated, have the same color, or flash synchronously with each other, or both are operated in a similar flashing sequence.

3. The method as recited in claim 2, wherein the signaling means of the two selected ports are simultaneously permanently illuminated and the signaling means of the other ports at least of these two network infrastructure devices are switched off or have a different brightness than that of the illuminated ports.

4. The method as recited in claim 2, wherein the signaling means of the two selected ports flash synchronously with each other and the signaling means of the other ports at least of these two network infrastructure devices flash in a phase-shifted manner, are switched off, or have a different brightness than that of the illuminated ports.

5. The method as recited in claim 1, wherein the signaling means of the two selected ports are activated in the same color.

6. The method as recited in claim 1, further comprising the step of:
initiating the method on a network infrastructure device or a network management station.

7. The method as recited claim 1, further comprising the steps of:
initially identifying the signaling means of the one network infrastructure device and the signaling means of another network infrastructure device; and then bringing the signaling means of the selected port of the one network infrastructure device and the signaling means of the selected port of other network infrastructure device into a signaling state indicating that they belong together.

8. The method as recited in claim 1, further comprising the step of:
unplugging the cable from the selected port of the one network infrastructure device;
connecting a device between the unplugged cable and the one network infrastructure device; and
then initiating the method of claim 1 at the two network infrastructure devices that are connected to each other via this cable.

9. The method as recited in claim 1, wherein, when the network infrastructure devices are not cabled to each other yet or are not all interconnected, the selected port of the one network infrastructure device and the selected port of another network infrastructure device are connected to each other via the cable.

10. The method as recited in claim 2, wherein the signaling means of the two selected ports are simultaneously operated in a similar decreasing and/or increasing flashing sequence.
